(19) United States
(12) Patent Application Publication
(10) Pub. No.: US 2004/0141630 A1
(43) Pub. Date: Jul. 22, 2004

(54) Method and apparatus for augmenting a digital image with audio data

(76) Inventors: Vasudev Bhaskaran, Sunnyvale, CA (US); Viresh Ratnakar, Sunnyvale, CA (US)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/347,340

(22) Filed: Jan. 17, 2003

(51) Int. Cl. G06K 9/00

(52) U.S. Cl. 382/100

(57) ABSTRACT

A method for providing a delivery scheme for an audio augmented photograph is defined. The method initiates with combining digital audio data and digital image data to define an audio augmented digital image. Then, the audio augmented digital image is transmitted to a receiving device. After receiving the audio augmented digital image, the audio data is extracted. Next, an audio augmented printed image is generated, wherein the audio augmented printed image includes visually imperceptible embedded audio data. Then, detection of the embedded audio data is enabled when the audio augmented printed image is scanned. A computer readable media, an image delivery system and devices configured to augment digital image data with audio data and transform an audio augmented digital photograph to an audio augmented printed photograph are also provided.

### CROSS REFERENCE TO RELATED APPLICATIONS

This application is related to: (1) U.S. Pat. No. 6,064,764, entitled “Fragile Watermarks for Detecting Tampering in Images,” and (2) U.S. patent application Ser. No. 09/270,258 filed Mar. 15, 1999, and entitled “Watermarking with Random Zero-Mean Patches for Copyright Protection.” Each of these related applications are herein incorporated by reference.

### BACKGROUND OF THE INVENTION

1. Field of the Invention

This invention relates generally to digital image technology and more particularly to a method and apparatus for augmenting a digital image or a printed image with audio data, enabling delivery of an audio augmented image through electronic systems or a hardcopy of the photograph.

2. Description of the Related Art

With digital photography being brought to the average household, there has been interest in providing audio data along with the digital image data. Digital cameras are capable of capturing audio data separate from the digital image data. As digital photography has become more popular, an interest in integrating audio data with pictures has simultaneously evolved.

FIG. 1 is a schematic diagram illustrating a printed photograph having a defined region for including audio data. Printing medium 100 includes regions 102 and 104 along with the still picture image. For example, regions 102 can include an optically readable voice code image, while region 104 includes data relating the audio data and the photographed still image. Alternatively, the audio data of FIG. 1 can be converted to a bar code and printed at the bottom, or some other region of printing medium 100.

The shortcomings of the scheme defined with reference to FIG. 1 include the reduction of the print area of the photograph or image. That is, the photograph or image is not allowed to occupy the entire region of printable area due to the area consumed by the audio data. Additionally, the audio augmented photograph is restricted to a print medium having the audio data. Furthermore, the amount of audio data capable of being included in the printed picture is directly related to the size of the picture. In order to fit the readable voice code image region and/or the data relating region, the digital image data of the photograph must be resealed prior to printing, thereby causing delays and requiring memory resources.

Another attempt to combine voice data with printed photos includes affixing a paperclip containing audio data to a corresponding printed photograph. The shortcomings of this scheme include the weak link connecting the audio data and the photograph, i.e., either of the two can be easily misplaced since there are two separate files. In addition a special reader is needed to retrieve the audio data. Therefore, a user would have to purchase an additional device to listen to the audio data. Again this scheme is restricted to printed photos. Thus, there does not exist any scheme to re-create a digital version with embedded audio of the printed photograph from the actual printed photograph and associated audio data.

As a result, there is a need to solve the problems of the prior art to provide a method and apparatus for providing the integration of audio data with a digital photograph not restricted to a printed photograph and the audio data does not impact the quality of the printed photograph.

### SUMMARY OF THE INVENTION

Broadly speaking, the present invention fills these needs by providing a method, a device and system for augmenting digital image data with audio data in an imperceptible manner, wherein the audio augmented image data is maintained throughout a delivery chain. It should be appreciated that the present invention can be implemented in numerous ways, including as a method, a system, computer readable media or a device. Several inventive embodiments of the present invention are described below.

In one embodiment, a method for augmenting digital image data with audio data is provided. The method initiates with defining the digital image data and the audio data. Then, the audio data is embedded into a portion of compressed digital image data; Next, a copy of the digital image data having embedded audio data is generated, wherein the embedded audio data is visually imperceptible.

In another embodiment, a method for augmenting a printed photograph with audio data in a manner imperceptible to a user is provided. The method initiates with modulating pixel data associated with the printed photograph while maintaining a printed image quality, wherein the modulated pixel data represents the audio data. Then, the modulated pixel data is captured through corresponding modulation of print channels associated with the modulated pixel data.

In yet another embodiment, a method for providing a delivery scheme for an audio augmented photograph is defined. The method initiates with combining digital audio data and digital image data to define an audio augmented digital image. Then, the audio augmented digital image is transmitted to a receiving device. After receiving the audio augmented digital image, the audio data is extracted. Next, an audio augmented printed image is generated, wherein the audio augmented printed image includes visually imperceptible embedded audio data. Then, detection of the embedded audio data is enabled when the audio augmented printed image is scanned.

In still yet another embodiment, a computer readable media having program instructions for augmenting digital image data with audio data is provided. The computer readable media includes program instructions for embedding the audio data into a portion of compressed digital image data. Program instructions for printing a copy of the digital image data having embedded audio data, wherein the embedded audio data is visually imperceptible are also included.

In another embodiment, an image delivery system capable of delivering audio augmented image data in an electronic format and a printed format is provided. The image delivery system includes a data embedder configured to combine digital audio data with digital image data to define audio augmented image data. The data embedder is configured to transmit the audio augmented image data. A display device configured to receive the audio augmented image data from the data embedder is included. The display device is configured to extract the digital audio data from the audio augmented image data to output the audio augmented image data as either an electronic image presented on a display screen or an audio augmented printed image, wherein the audio data of the audio augmented printed image is visually imperceptible.

In yet another embodiment, a display device configured to transform an audio augmented digital photograph to an audio augmented printed photograph is provided. The display device includes data extraction circuitry configured to extract audio data from an audio augmented digital photograph. Halftone data embedder circuitry configured to modulate print channels in an imperceptible manner is also included. The modulated print channels correspond to modulated pixel data. The modulated pixel data represents the extracted audio data.

In still yet another embodiment, a device configured to augment digital image data with audio data is provided. The device includes data embedder circuitry configured to embed the audio data into the digital image data, wherein the audio data is defined by modifying a least significant bit of a block of the digital image data.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a schematic diagram illustrating a printed photograph having a defined region for including audio data.

FIG. 2 is a high level schematic diagram of a delivery cycle of a digital image having audio embedded data in accordance with one embodiment of the invention.

FIG. 3 is a more detailed block diagram of the delivery cycle of the digital image having audio embedded data illustrated in FIG. 2.

FIG. 4 is a block diagram illustrating the conversion of an audio augmented printed photograph into audio augmented image data in accordance with one embodiment of the invention.

FIG. 5 is a flow chart diagram illustrating a method to embed audio bits into an image in the frequency domain associated with a Joint Photographic Experts Group (JPEG) image in accordance with one embodiment of the invention.

FIG. 6 is a flowchart diagram illustrating a method of extracting audio data bits from audio augmented image data in accordance with one embodiment of the invention.

FIG. 7 is a simplified schematic diagram illustrating the embedding of audio bits within digital image data in accordance with one embodiment of the invention.

FIGS. 8A through 8D are schematic representations of four basic zero-mean patches in accordance with one embodiment of the invention.

FIG. 9 is a schematic diagram of an image area aligned with a patch in accordance with one embodiment of the invention.

FIG. 10 is a flowchart diagram illustrating a method for embedding information into a image data conveyed by a digital signal in accordance with one embodiment of the invention.

FIG. 11 is a flowchart diagram illustrating a method for detecting embedded audio data in accordance with one embodiment of the invention.

FIG. 12 is a flowchart diagram illustrating a method providing a delivery scheme for an audio augmented photograph in accordance with one embodiment of the invention.

### DETAILED DESCRIPTION OF THE PREFERRED EMBODIMENTS

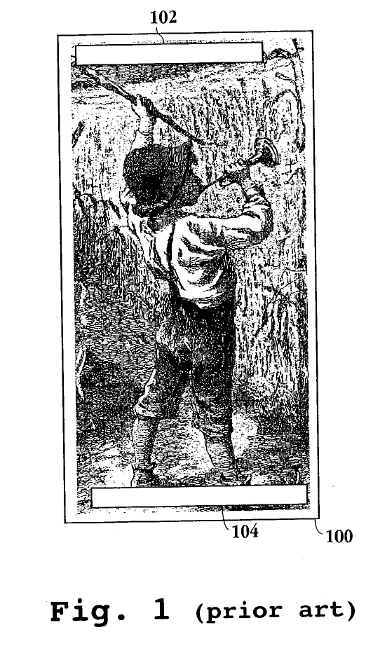

An invention is described for a system, device and method for integrating audio data with image data in an imperceptible manner when the image data is viewed in a softcopy format or a hardcopy format. It will be obvious, however, to one skilled in the art, that the present invention may be practiced without some or all of these specific details. In other instances, well known process operations have not been described in detail in order not to unnecessarily obscure the present invention. FIG. 1 is described in the “Background of the Invention” section. The term about as used to herein refers to +/−10% of the referenced value.

The embodiments of the present invention provide a system and method for augmenting digital image data and printed photographs generated from the digital image data, with audio. The audio augmented digital images and the audio augmented printed photographs are capable of being presented in either a softcopy or a hardcopy format. For example, the audio augmented digital images may be provided to a screen phone, personal digital assistant (PDA), cellular phone or some other consumer electronic device having a photo viewer enabling the softcopy of the audio augmented digital image to be viewed.

Similarly, the audio augmented printed photographs may be provided by a printing device. In one embodiment, the pixel values associated with audio augmented digital images are modulated to imperceptibly modify the yellow and black dots of the printout, i.e., audio augmented printed photograph. The pixel modulation can then be detected by scanning the printed image and running a detection utility program to identify the audio data associated with the pixel modulation. Accordingly, the audio augmentation is preserved and reproducible through the entire delivery cycle of the photograph, which includes delivery of the digital image data to the printer and the delivery of the printed image data. That is, the audio stays embedded in the photograph/image irrespective of whether the photograph/image is in the initial electronic form or the printed form. Furthermore, the audio is embedded in a manner that is visually imperceptible in the electronic form or the printed form. That is, the modification of a DCT coefficient for the electronic form and/or the pixel modulation of the printed form, as described in more detail below, can not be detected by a human eye when viewed in either the electronic form or the printed form. Accordingly, there is not a visibly noticeable region set aside in the electronic form or the printed form for the audio data. In turn, the visual quality of the photograph/image is substantially preserved in either the electronic form or the printed form.

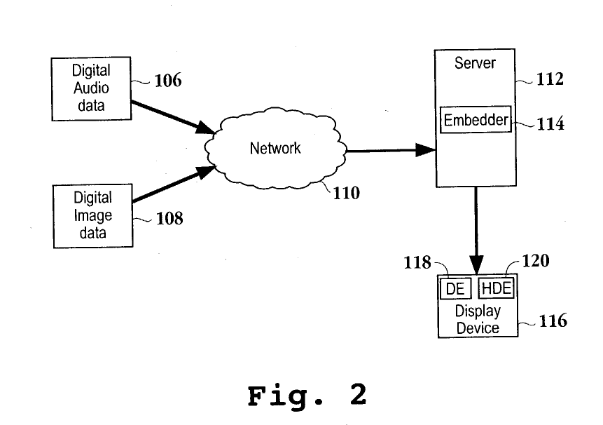

FIG. 2 is a high level schematic diagram of a delivery cycle of a digital image having audio embedded data in accordance with one embodiment of the invention. Digital audio data 106 and digital image data 108 are transmitted over network 110 to server 112. Server 112 includes embedder 114, which is configured to embed audio data 106 into digital image data 108. In one embodiment, audio data 106 is compressed to a compressor prior to being embedded. For example, the compressor may use about a 30:1 compression ratio. The audio augmented image data defined by the combination of audio data 106 and image data 108 is then transmitted to display device 116. Display device 116 includes data extractor (DE) 118 and halftone data embedder (HDE) 120. Data extractor 118 is configured to extract audio data 106 from the audio augmented image data. In one embodiment, where display device 116 includes a viewable screen, the audio augmented image data may be displayed while audio data 106 is played back. In another embodiment, where display device 116 includes printer functionality to produce a printout, audio data 106, which is extracted from the audio augmented image data by data extractor 118, is used to modulate pixel data and print a representation of the modulated pixel data through halftone data embedder 120. The modulated pixel data is captured in the printout and represents the audio data. It should be appreciated that the pixel modulation captured in the printout is visually imperceptible to a user. In one embodiment, the black (K) and yellow (Y) print channels of the printer are modulated to represent embedded audio data 106. Specifically, this involves modifying small blocks of halftone dots so as to force a positive or negative correlation with a specific zero-mean reference block. Accordingly, the sign of the correlation is chosen as positive or negative depending upon the 1/0 value of the bit to be embedded.

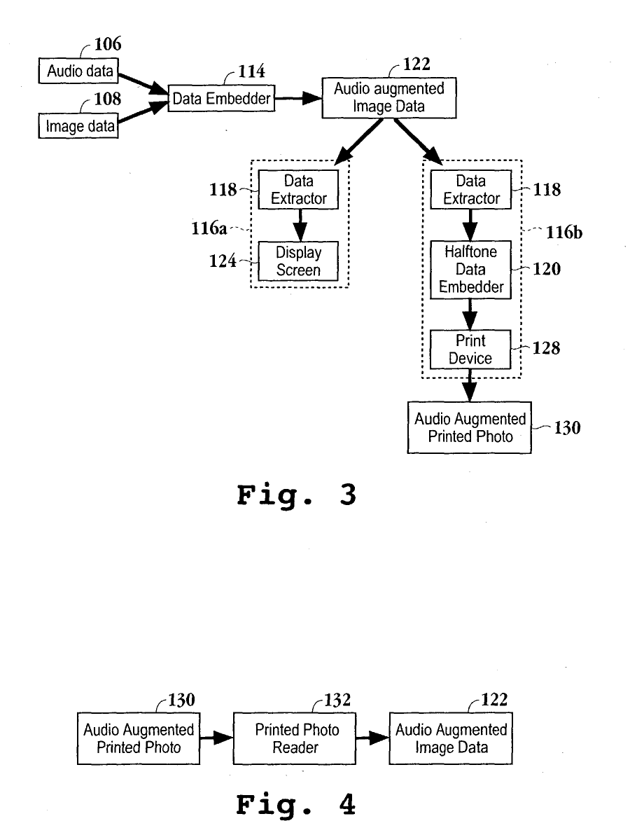

FIG. 3 is a more detailed block diagram of the delivery cycle of the digital image having audio embedded data illustrated in FIG. 2. Here, audio data 106 is embedded into image data 108 through data embedder 114. For example, a digital camera, or even a digital camcorder configured to take photographs, may capture a few seconds of audio along with a digital image. Data embedder 114 is configured to embed audio data 106 within image data 108. It should be appreciated that data embedder 114 may be included in a server where the audio data and the image data are transmitted to the server as discussed with reference to FIG. 2, or the data embedder may be included in a digital camera, camcorder or any other electronic device configured to provide a digital image and capture audio data. Thus, once audio data 106 and image data 108 are captured, then the audio data can be combined with the image data to define audio augmented image data 122. Audio augmented image data 122 is then transmitted to a display device for presentation or printout. Display device 116a represents a display device configured to display a softcopy, e.g., an electronic copy viewable on a display screen while the audio data is played back, of audio augmented image data 122. Display device 116b represents a display device configured to display a hardcopy, e.g., a printout, of audio augmented image data 122, wherein the audio data is visually imperceptible.

Still referring to FIG. 3, display device 116a includes data extractor 118 and display screen 124. Display device 116b includes data extractor 118, halftone data embedder 126, and print device 128. Print device 128 is enabled to output audio augmented printed photograph 130, where audio data 106 is embedded into the printout in a visually imperceptible manner. It will be apparent to one skilled in the art that display devices 116a and 116b may be incorporated into a single unit, as illustrated with reference to FIG. 2. For example, display device 116a and 116b may be included with a general purpose computer, including a display screen, in communication with a print device, wherein the print device may be a commercially available printer, an all in one peripheral device, or any other peripheral device having print functionality. It should be appreciated that an all in one peripheral device is a device having printer/fax/copier/scanner functionality.

FIG. 4 is a block diagram illustrating the conversion of an audio augmented printed photograph into audio augmented image data in accordance with one embodiment of the invention. Here, audio augmented printed photograph 130 is read or scanned by printed photograph reader 132. In one embodiment, printed photograph reader 132 is enabled to detect the visually imperceptible modulation of the black and yellow dots of audio augmented printed photograph 130, in order to recreate audio augmented image data 122 from the printed photograph. It will be apparent to one skilled in the art that printed photograph reader 132 can take the form of a scanner that is portable or a desk top scanner, or any suitable device for scanning audio augmented printed photograph 130 to detect the embedded audio data.

In the embodiments described above it should be appreciated that data embedder 114 embeds the audio data into the image data. Then, data extractor 118 extracts the embedded audio data from the audio augmented image data. That is, data extractor 118 essentially reverses the effects of data embedder 114. Similarly, halftone data embedder 120 modulates the pixel image data to create an audio augmented printed photograph where the audio data corresponds to the modulated pixel data. Printed photograph reader 132 then translates the modulated pixel data to recreate the audio augmented image data. Thus, printed photograph reader 132 essentially reverses the effects of halftone data embedder 120.

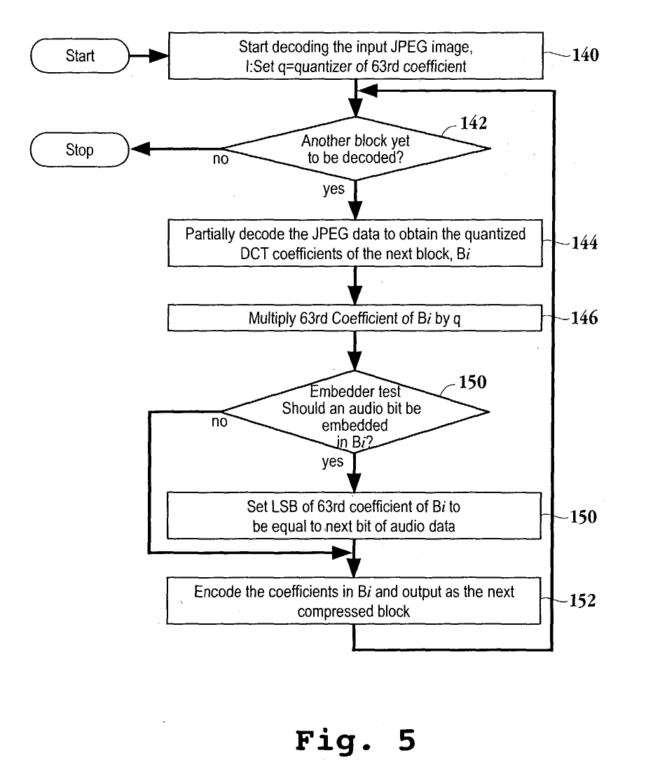

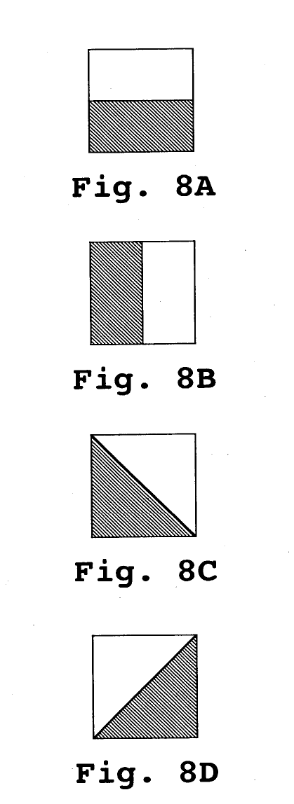

Described below are exemplary methods for 1) embedding the audio data into the image data to create audio augmented image data, 2) extracting the embedded audio from the audio augmented image data, 3) modulating the pixel data to embed the audio data in an audio augmented printed photograph, and 4) translating the modulated pixel data incorporated into the audio augmented printed photograph to recreate the audio augmented image data. FIGS. 5-7 correspond to exemplary methods for 1) and 2), while FIGS. 8A-D, and 9-11 correspond to exemplary methods for 3) and 4).

FIG. 5 is a flow chart diagram illustrating a method to embed audio bits into an image in the frequency domain associated with a Joint Photographic Experts Group (JPEG) image in accordance with one embodiment of the invention. The method initiates with operation 140 where a JPEG image, I, is fed to a decoder which parses its headers noting the value of q, the quantizer for the 63^{rd} coefficient (with coefficient numbers being in the range [0 . . . 63]). The method advances to decision operation 142 where it is determined if another block is to be decoded. If there is another block of coefficients yet to be decoded and processed (operation 142), the next such block, Bᵢ, is partially decoded in operation 144. Here, only the entropy coding of the compressed data is undone, avoiding the de-zig-zagging, dequantization, and IDCT steps needed for full decompression. This results in a representation of Bᵢ made up of only the non-zero quantized coefficients (except for the 63^{rd} coefficient which is always included in the representation) along with their locations in the zig-zag order. The 63^{rd} coefficient of each block is multiplied by the q, in operation 146. It should be appreciated that this is done so that subsequent modifications to some of the 63^{rd} coefficients have minimal visual impact. EMBEDDER-TEST is performed in decision operation 148 to determine whether block Bᵢ is supposed to embed the next audio bit. EMBEDDER-TEST is fully described as follows below.

For color images, audio bits are embedded only in the luminance plane of the image. This is done so that during decompression, when the luminance-chrominances color representation is converted back to red, green, and blue pixel values (RGB), the resulting distortion is minimized. Moreover, the chrominance planes are typically sub-sampled, so any distortion in a single chrominance block results in distortions in several RGB blocks. Thus, in grayscale images as well as in color images, audio bits are embedded only in the color component numbered zero (which is the luminance plane for color images). To minimize the distortion, audio bits are embedded only in the 63^{rd} DCT coefficient, as mentioned previously. To minimize the compressed size, only those blocks are chosen to embed an audio bit where the 63^{rd} coefficient is already non-zero. This follows from the observation that changing a zero value to a non-zero value results in a far greater increase in compressed size, compared to changing a non-zero value to another non-zero value.

However, since EMBEDDER-TEST will also be performed by the audio verification procedure, the blocks where the 63^{rd} coefficient (dequantized) is plus or minus 1 are not chosen as embedders in one embodiment of the invention. It should be appreciated that the coefficient might potentially be turned to zero on embedding the audio bit, and then the verifier will not be able to decide if the block is to be an embedder. If, at some point, the number of audio bits remaining to be embedded becomes equal to the number of blocks remaining in component zero, every subsequent block in component zero is decided upon as an embedder of an audio bit.

Returning to FIG. 5, the determination of whether Bᵢ is supposed to embed the next audio bit may be made again on a block-by-block basis. If block Bᵢ is supposed to embed the next audio bit, then the least significant bit (LSB) of the 63^{rd} discrete cosine transform (DCT) coefficient of Bᵢ is set to match the next audio bit in operation 150 and the method proceeds to operation 152. If the decision in operation 148 is “no”, then the method directly proceeds to operation 152. In operation 152, the coefficients in Bᵢ are encoded and produced as output into the compressed data stream for the audio augmented image data, Iₐ. It should be appreciated that the quantized coefficients of Bᵢ that are used enable efficient encoding, as the quantized coefficients are already in the zig-zag order, thus avoiding the DCT, quantization, and zig-zagging steps generally required for compression. The process repeats until all of the blocks have been processed.

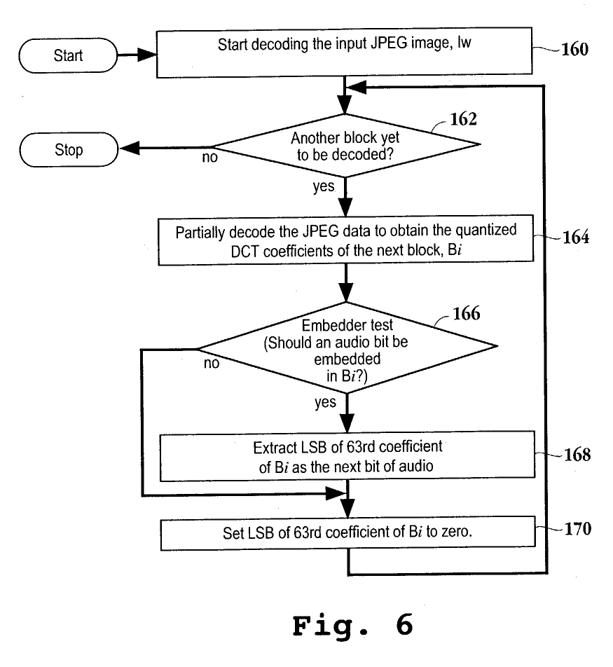

FIG. 6 is a flowchart diagram illustrating a method of extracting audio data bits from audio augmented image data in accordance with one embodiment of the invention. The method initiates with decoding the JPEG input image, Iₐ, in operation 160. Here the headers for the input image are parsed. In decision operation 162, it is determined whether another block remains to be decoded. If another block is to be decoded the method proceeds to operation 164 where the next block, Bᵢ, is partially decoded. Similar to operation 144 of FIG. 5, only the entropy coding of the compressed data is undone, avoiding the de-zig-zagging, dequantization, and IDCT steps needed for full decompression. This results in a representation of Bᵢ made up of only the non-zero quantized coefficients (except for the 63^{rd} coefficient which is always included in the representation) along with their locations in the zig-zag order. EMBEDDER-TEST is performed in operation 166 to determine whether block Bᵢ is supposed to embed the next audio bit. If the next audio bit is to be embedded, then the LSB of the 63^{rd} coefficient of Bᵢ is extracted as the next audio bit in operation 168. The process continues through all the blocks and in the end, the extracted audio bits have been fully computed. It should be appreciated that similar techniques for embedding and extracting the audio bits may be applied in the spatial domain as well. More specifically, instead of the highest-frequency coefficients, all or some of the pixels can be directly used as audio bit embedders by setting their LSB to the audio bit.

With reference to FIGS. 8A-D and 9-11 discuss a method for modulating pixel data to embed audio data and the subsequent detection of the embedded audio data from a printed format is carried out by processing signals with zero-mean patches. The term “patch” refers to a set of discrete elements that are arranged to suit the needs of each application in which the method described herein is used. In image processing applications, the elements of a single patch are arranged to coincide with digital image “pixels” or picture elements. In one embodiment, when the digital image is being printed on paper, the term pixel is used herein to denote a single halftone dot. A halftone dot on a printed image is either on or off, and accordingly, ink or toner is either applied or not applied to that location. Patch elements may be arranged in essentially any pattern. Throughout the following embodiments patch elements are arranged within a square area, however, no particular arrangement of patch elements is critical to the practice of the embodiments described herein.

The term “zero-mean patch” refers to a patch that comprises elements having values the average of which is substantially equal to zero. An average value is substantially equal to zero if it is either exactly equal to zero or differs from zero by an amount that is arithmetically insignificant to the application in which the zero-mean patch is used. A wide variety of zero-mean patches are possible but, by way of example, only a few basic patches with unit magnitude elements are disclosed herein.

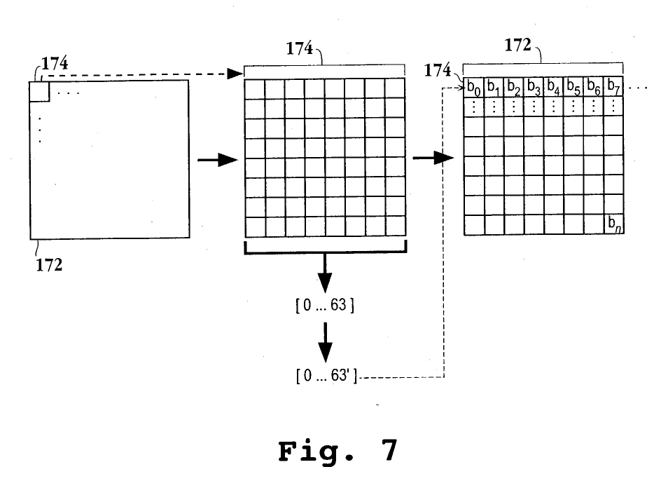

FIG. 7 is a simplified schematic diagram illustrating the embedding of audio bits within digital image data in accordance with one embodiment of the invention. Here, image 172 is composed of a plurality of blocks, such as block 174. Block 174 in turn is composed of a number of blocks. For example, for a JPEG image one skilled in the art will appreciate that the discrete cosine transform (DCT) representation is based on 8×8 blocks. Accordingly, block 174 is an 8×8 block portion of image 172. A DCT value is calculated for each 8×8 block. The DCT value is represented by coefficients 0-63. The 63^{rd} coefficient, i.e., the least significant bit, is then modified to 63′ to indicate an audio bit. Thus, each 8×8 block of image 172 includes 1 bit of audio data. Here, audio bit b₀ is incorporated into block 174 of image 172. In one embodiment, one audio bit may be incorporated into each 8×8 block of image 172 without impacting the quality of the presented image. It should be appreciated that FIG. 7 is exemplary and is not meant to limit the invention to embedding the audio data within the compressed domain. Accordingly, the audio data may be combined with raw image data as well. For example, audio bits may be embedded in the least significant byte of uncompressed image data, i.e., raw image data. It will be apparent to one skilled in the art that the schemes described herein may be applied to compressed image data as well uncompressed image data.

It will be apparent to one skilled in the art that many digital cameras have 3 mega pixel sensors. Thus, the images generated by theses cameras are typically 2048×1536 pixels. If it is desired to store 10 seconds of audio data in such an image, then at 8 kilohertz and 8 bits per sample, 640 kilobits of audio is required (8000 samples/second×8 bits/sample×10 seconds). Of course, this assumes voice grade quality audio as opposed to compact disc quality audio. Assuming a 32:1 compression, which is typical for speech, it is necessary to store/embed approximately 20 kilobits of compressed audio data within the digital image. In one embodiment, one bit of audio data is hidden per 64 pixels (one 8×8 block) without affecting image quality. Therefore, with a 2048×1536 image, 49,152 bits of audio data can be hidden, easily accommodating 10 seconds of audio data. Accordingly, even a digital camera with a 2 mega pixel sensor would be able to accommodate 10 seconds of audio data.

FIGS. 8A through 8D are schematic representations of four basic zero-mean patches in accordance with one embodiment of the invention. It will be apparent to one skilled in the art that four additional patches may be formed by reversing the shaded and non-shaded areas of FIGS. 8A-D. The shaded area in each patch represents patch elements having a value of −1. The non-shaded area in each patch represents patch elements having a value of +1. As illustrated, the boundary between areas is represented as a straight line, however, the boundary in an actual patch is chosen so that exactly half of the patch elements have a value equal to +1 and the remaining half of the elements have a value of −1. If a patch has an odd number of elements, the center element is given a value of zero. When a patch is “applied” to the image at a particular location, halftone dots in the image that coincide with the patch are modified so as to force a positive or negative correlation. The amount of modification made to the halftone dots (i.e., the number of halftone dots turned on or off) can be varied over various image areas so as to minimize the visual perception of the changes.

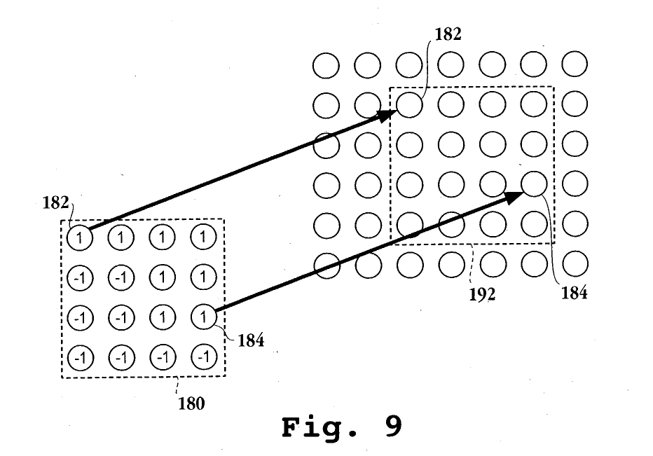

Several zero-mean patches within an area of the image are designated as “anchor patch elements” and are used during data extraction to align the locations from which the data bits are extracted. Accordingly, during embedding, the correlations forced at the anchor patch locations determine a fixed bit pattern. For ease of discussion and illustration, the following disclosure and the accompanying figures assume each patch comprises a square array of unit-magnitude. Referring to FIG. 9, patch 180 corresponds to the basic patch shown in FIG. 8C that comprises a 4×4 array of patch elements.

FIG. 9 is a schematic diagram of an image area aligned with a patch in accordance with one embodiment of the invention. Broken line 192 corresponds to the outline of patch 180 when it is aligned in the image area. During embedding, halftone dots may be added to locations aligned with +1 on the patch, such as location 180, and may be removed from locations aligned with −1 on the patch, such as location 184, if the bit to be embedded is 1. This would force a positive correlation with the patch. Alternatively, if the bit to be embedded is 0, then dot addition/subtraction is reversed, so as to force a negative correlation.

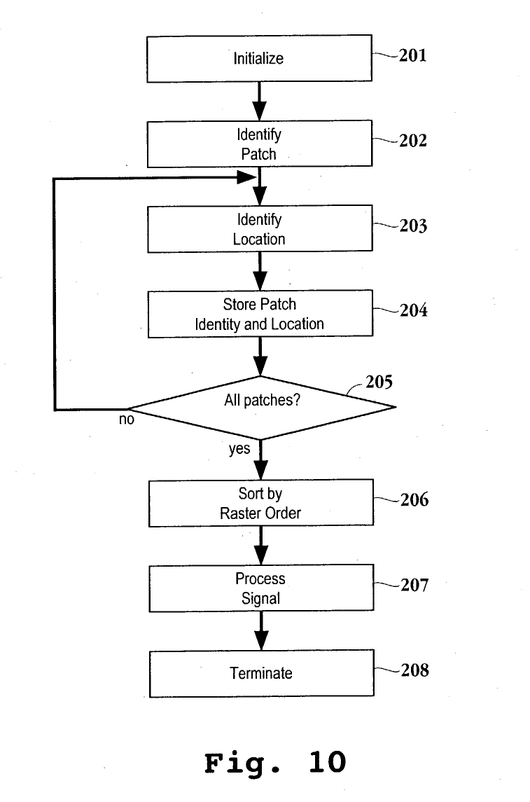

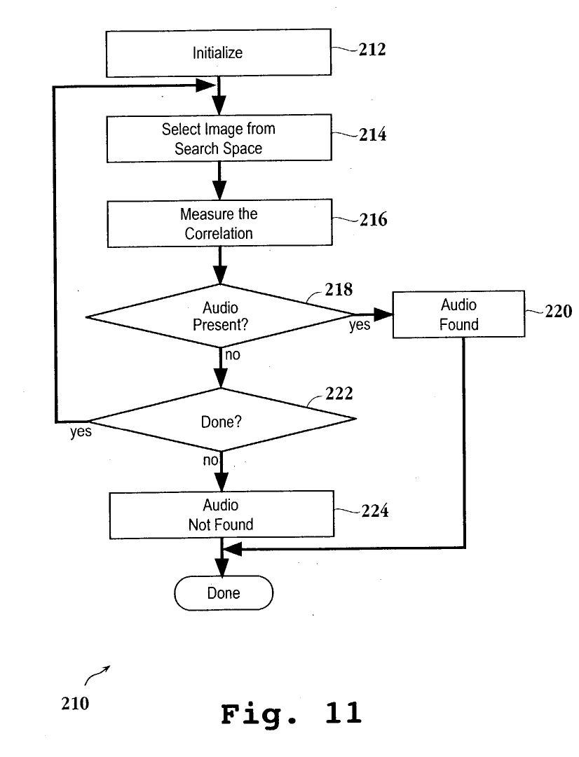

FIG. 10 is a flowchart diagram illustrating a method for embedding information into a image data conveyed by a digital signal in accordance with one embodiment of the invention. In this embodiment, the signal elements are processed in raster order. This embodiment reduces the memory required to store the digital signal and also reduces the processing delays required to receive, buffer, process and subsequently transmit the digital signal. The method initiates with operation 201 where initialization activities, such as initializing a random number generator or initializing information used to control the execution of subsequent steps, are executed. Operation 202 identifies and selects a patch from a plurality of zero-mean patches. Operation 203 identifies the image location where the patch is to be applied. Operation 204 stores the identity (the information needed to reproduce the patch, such as the bits produced by the random number generator) and patch locations for subsequent use. If the information conveyed by the digital signal is to be processed for more than one patch, operation 205 determines if all patches have been selected. If not, operations 202 and 203 continue by selecting another patch and another location in the digital signal.

When all patches have been selected, operation 206 obtains the locations and patch identities stored by operation 204 and sorts this information by location according to raster order. For example, if the digital signal I is represented by signal elements arranged in lines, this may be accomplished by a sort in which signal element position by line is the major sort order and the position within each line is the minor sort order.

Operation 207 of FIG. 10 then processes the digital signal. Here, patches are applied by combining patch elements with signal elements. Because signal elements are processed in raster order, the entire digital signal does not need to be stored in memory at one time. Each signal element can be processed independently. This method is particularly attractive in applications that wish to reduce implementation costs by reducing memory requirements and/or wish to reduce processing delays by avoiding the need to receive an entire digital signal before performing the desired signal processing. Operation 208 carries out the activities needed to terminate the method.

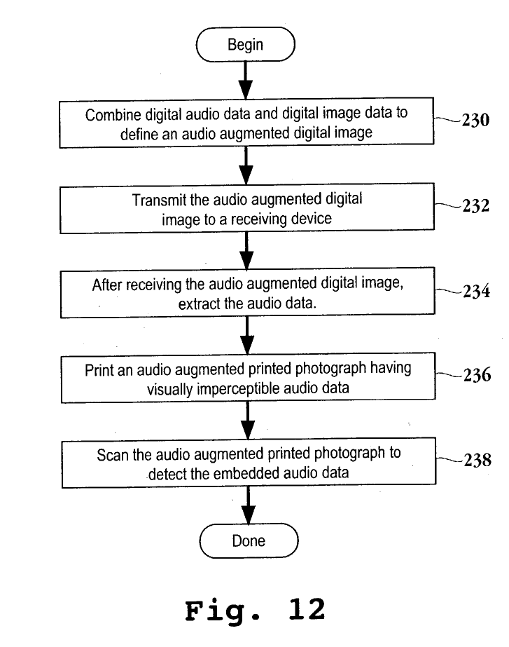

FIG. 11 is a flowchart diagram illustrating a method for detecting embedded audio data in accordance with one embodiment of the invention. Operation 212 performs initialization activities. Operation 214 selects an image location and search angle from the search space. In one embodiment, the alignment step of operation 214 is performed because the printing operation is not capable of putting all the dots at the desired places. Accordingly, a search over a few starting points and a small range of angles is performed, i.e., the patches embed a fixed pattern that can be checked. Operation 216 measures the correlation between the selected image and the patches at the anchor patch locations. If the resulting bit pattern matches the fixed bit pattern used during embedding, then decision operation 218 determines that the audio data is present in the selected image. In that case, operation 220 generates an indication that the audio data is present, extracts the audio data bits from the non-anchor locations, and terminates the method. Otherwise, operation 222 determines whether any other locations/angles are to be selected from the search space and are to be examined. If so, the method returns to operation 214. If not, operation 224 generates an indication that the audio data was not found and terminates the method.

The presence of audio data in a suspected digital signal J may be checked using an audio checking procedure such as that illustrated in the following program fragment. If the routine returns the value False, it only means a particular audio bit was not found in the image search space. A larger search space can be used if desired.

CheckAudio(J)

Set a search space of starting locations and angles

For each location/angle

Measure correlations at anchor patch locations to get bit-pattern

If the extracted bit-pattern matches the known fixed pattern then

Measure correlations at non-anchor locations to get audio bits

Return True

Return False

FIG. 12 is a flowchart diagram illustrating a method providing a delivery scheme for an audio augmented photograph in accordance with one embodiment of the invention. The method initiates with operation 230, where digital audio data and digital image data are combined to define an audio augmented digital photograph. For example, the audio data may be embedded in the image data as discussed above with reference to FIGS. 5-7. It should be appreciated that the audio data and the image data may be captured during the same event, such as a digital camera configured to capture audio when taking a picture. Alternatively, the audio data and the image data can originate from separate sources and then be combined through a data embedder sitting on a server or some other remote location as illustrated with reference to FIGS. 2 and 3. The method then advances to operation 232 where the audio augmented digital photograph is transmitted to a receiving device. In one embodiment, the receiving device is enabled to provide printouts of the audio augmented digital image as well as display the image. The method then proceeds to operation 234, where after receiving the audio augmented digital image, the embedded audio data is extracted from the audio augmented digital image. For example, the audio data may be extracted from the image data as discussed above with reference to FIGS. 5-7.

The method of FIG. 12, then moves to operation 236, where an audio augmented printed photograph having visually imperceptible audio data embedded in the printout is provided. In one embodiment, the extracted audio data from operation 234 is used to modulate pixel data, i.e., modulate print channel of the device providing the printout. For example the black and yellow print channels may be modulated, wherein the modulation represents the audio data. An exemplary method for providing an audio augmented printed photograph is discussed with reference to FIGS. 8A-D, and 9-11. It should be appreciated that any print receiving object may be used as print medium for the audio augmented printed photograph, e.g., various forms and qualities of paper, overheads, etc. The method then advances to operation 238, where the audio augmented printed photograph is scanned to detect the embedded audio data. In one embodiment, the scanning detects the modulation of the print channels captured in the photograph as described above with reference to FIGS. 8A-D and 9-11. Thus, a complete delivery cycle for the audio augmented digital image from electronic format to printed format and back to electronic format is provided. Accordingly, a user is provided with the options of an electronic version of the data or a hardcopy version of the data, thereby increasing the user's options with respect to portability of the combined audio and image data.

It should be noted that the block and flow diagrams used to illustrate the audio insertion, extraction and verification procedures of the embodiment described herein, illustrate the performance of certain specified functions and relationships thereof. The boundaries of these functional blocks have been arbitrarily defined for the convenience of description. Alternate boundaries may be defined so long as the specified functions and relationships thereof are appropriately formed. Moreover, the flow diagrams do not depict syntax or any particular programming language. Rather, they illustrate the functional information one skilled in the art would require to fabricate circuits or to generate software to perform the processing required. Each of the functions depicted in the block and flow diagrams may be implemented, for example, by software instructions, a functionally equivalent circuit such as a digital signal processor circuit, an application specific integrated circuit (ASIC) or combination thereof. Further details with reference to combining the audio data and the image data as described in FIGS. 5-7 are provided in U.S. Pat. No. 6,064,764 which has been incorporated by reference. Further details with reference to embedding the audio data into a printout of the image data as described in FIGS. 8A-D and 9-11 are provided in U.S. patent application Ser. No. 09/270,258 which has been incorporated by reference.

In summary, the above described invention describes a scheme for embedding audio data into image data in a digital format and a scheme for augmenting a printout with audio data. Thus, through the combination of the schemes a complete delivery cycle is defined. That is, the audio data is always included within the image data irrespective of whether the image data is in digital form or analog (printed) form. Furthermore, specialized hardware is not needed for the transportability of the augmented audio as it is embedded within the image data in either format.

With the above embodiments in mind, it should be understood that the invention may employ various computer-implemented operations involving data stored in computer systems. These operations include operations requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The above described invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a communications network.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for augmenting digital image data with audio data, comprising:
identifying the digital image data and the audio data;
embedding the audio data into a portion of compressed digital image data; and
generating a copy of the digital image data having embedded audio data, wherein the embedded audio data is visually imperceptible to a human eye.

2. The method of claim 1, further comprising:
transmitting the digital image data having embedded audio data to a display device; and
extracting the audio data for playback with a presentation of the digital image on a display screen associated with the display device.

3. The method of claim 1, wherein the portion of compressed digital image data is defined by a plurality of blocks and the portion of compressed digital image data is defined by a set of blocks.

4. The method of claim 3, wherein each block is capable of storing a bit of the audio data.

5. The method of claim 1, wherein the method operation of embedding the audio data into a portion of compressed digital image data includes,
modifying a least significant bit of a block of the digital image data.

6. The method of claim 1, wherein the method operation of generating a copy of the digital image data having embedded audio data includes,
modulating print channels to represent the audio data.

7. A method for augmenting a printed photograph with audio data in a manner imperceptible to a human eye, comprising:
modulating pixel data associated with the printed photograph the modulating maintaining a substantially constant printed image quality, wherein the modulated pixel data includes the audio data; and
applying the modulated pixel data to a print receiving object by modulating print channels associated with the modulated pixel data.

8. The method of claim 7, wherein the method operation of modulating pixel data associated with the printed photograph while maintaining a substantially constant printed image quality includes,
modulating pixel data associated with colors selected from the group consisting of yellow and black.

9. The method of claim 7, wherein a halftone data embedder captures the modulated pixel data.

10. The method of claim 7, further comprising:
printing the photograph, wherein the printed photograph is configured to be scanned in order to detect the audio data.

11. A method for providing a delivery scheme for an audio augmented photograph, comprising:
combining digital audio data and digital image data to define an audio augmented digital image;
transmitting the audio augmented digital image to a receiving device;
extracting the audio data after receiving the audio augmented digital image;
generating an audio augmented printed image, the audio augmented printed image including visually imperceptible embedded audio data; and
enabling detection of the embedded audio data when the audio augmented printed image is scanned.

12. The method of claim 11, further comprising:
capturing the embedded audio; and
re-creating the audio augmented digital image from the audio augmented printed image.

13. The method of claim 11, wherein the method operation of combining digital audio data and digital image data to define an audio augmented digital image includes,
modifying a least significant bit of a block of the digital image data to represent a bit of the audio data.

14. The method of claim 11, wherein the method operation of generating an audio augmented printed image includes,
modulating print channels to represent the audio data in the audio augmented printed image.

15. A computer readable media having program instructions for augmenting digital image data with audio data, comprising:
program instructions for embedding the audio data into a portion of compressed digital image data; and
program instructions for printing a copy of the digital image data having embedded audio data, wherein the embedded audio data is visually imperceptible to a human eye.

16. The computer readable media of claim 15, further comprising:
program instructions for transmitting the digital image data having embedded audio data to a display device; and
program instructions for extracting the audio data for playback with a presentation of the digital image on a display screen associated with the display device.

17. The computer readable media of claim 15, wherein the program instructions for embedding the audio data into a portion of compressed digital image data includes,
program instructions for modifying a least significant bit of a block of the digital image data.

18. The computer readable media of claim 15, wherein the program instructions for printing a copy of the digital image data having embedded audio data includes,
program instructions for modulating print channels to represent the audio data.

19. An image delivery system capable of delivering audio augmented image data in an electronic format and a printed format, comprising:
a data embedder configured to combine digital audio data with digital image data to define audio augmented image data, the data embedder configured to transmit the audio augmented image data; and
a display device configured to receive the audio augmented image data from the data embedder, the display device configured to extract the digital audio data from the audio augmented image data to output the audio augmented image data as one of an electronic image presented on a display screen and an audio augmented printed image, wherein the audio data of the audio augmented printed image is visually imperceptible to a human eye.

20. The image delivery system of claim 19, wherein the display device is a printing device having a display screen.

21. The image delivery system of claim 19, further comprising:
a compressor enabled to provide compressed audio data to the data embedder.

22. The image delivery system of claim 19, wherein the display device includes:
a data extractor enabled to extract audio data from the audio augmented image data; and
a halftone data embedder enabled to incorporate modulated pixel data into the audio augmented printed image.

23. The image delivery system of claim 19, further comprising:
a reading device enabled to scan the audio augmented printed image, the reading device configured to capture the audio data and the image data of the audio augmented printed image to re-create the audio augmented image data in electronic format.

24. A display device configured to transform an audio augmented digital photograph to an audio augmented printed photograph, comprising:
data extraction circuitry configured to extract audio data from an audio augmented digital photograph; and
halftone data embedder circuitry configured to modulate print channels in an imperceptible manner to a human eye, the modulated print channels corresponding to modulated pixel data, the modulated pixel data representing the extracted audio data.

25. The display device of claim 24, further comprising:
a viewable screen for displaying the audio augmented digital photograph.

26. The display device of claim 24, further comprising:
a printing device configured to generate the audio augmented digital photograph.

27. A device configured to augment digital image data with audio data, comprising:
data embedder circuitry configured to embed the audio data into the digital image data, wherein the audio data is defined by modifying a least significant bit of a block of the digital image data.

28. The device of claim 27, wherein the device is a digital camera.

29. The device of claim 27, wherein the digital image is a Joint Photographic Expert Group (JPEG) format.
